(19) United States
(12) Patent Application Publication
(10) Pub. No.: US 2019/0052736 A1
(43) Pub. Date: Feb. 14, 2019

(54) PDU STRUCTURES

(71) Applicant: Nokia Technologies Oy, Espoo (FI)

(72) Inventors: Saumuli TURTINEN, Ii (FI); Timo KOSKELA, Oulu (FI); Vinh VAN PHAN, Oulu (FI)

(21) Appl. No.: 15/759,968

(22) PCT Filed: Sep. 21, 2016
(86) PCT No.: PCT/FI2016/050654

§ 371 Date: Mar. 14, 2018

Related U.S. Application Data
(60) Provisional application No. 62/234,840, filed on Sep. 30, 2015.

(51) Int. Cl. H04L 29/08; H04L 29/06; H04W 28/06

(52) U.S. Cl. CPC H04L 69/322; H04W 28/065; H04L 69/03; H04L 69/22

(57) ABSTRACT

Methods, apparatus and computer program products are disclosed for structuring Protocol Data Units (PDU). A method comprises: structuring a protocol data unit to include at least one special field in a header part of the protocol data unit and a padding part of the protocol data unit, wherein the at least one special field part indicates a length of the header part and wherein a length of the padding part is based at least on the indicated length of the header part; mapping the protocol data unit onto the trans port block scheduled for transmission between a source entity and a target entity, and transmitting the transport block from the source entity.

### CROSS REFERENCE TO RELATED APPLICATION

This application claims the benefit of U.S. Provisional Application No. 62/234,840 entitled “PDU Structures” filed on Sep. 30, 2015, which is incorporated herein by reference in its entirety.

### TECHNICAL FIELD

This invention relates generally to radio access technologies, and, more specifically, relates to Protocol Data Units (PDU) structures.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section.

Currently, Medium Access Control (MAC) and Radio Link Control (RLC) PDU header processing is based on the usage of extension bits which the decoding entity uses to determine what will follow after each field of the PDU.

### BRIEF DESCRIPTION OF THE DRAWINGS

These and other features, aspects, and advantages of the present invention will become better understood with regard to the following description, appended claims, and accompanying drawings, where:

FIG. 1 is a block diagram of one possible and non-limiting exemplary system in which the exemplary embodiments may be practiced;

FIG. 2 is an example LTE MAC PDU structure;

FIG. 3 is first example PDU format with an HLI field according to embodiments described herein;

FIG. 4 is a second example PDU format with an HLI field indicating padding in the PDU according to embodiments described herein;

FIG. 5 is a third example PDU format with HLI field and padding in the PDU header according to an embodiments described herein;

FIG. 6 is fourth example PDU format with HLI field and padding in the PDU header according to embodiments described herein;

FIG. 7 is a fifth example PDU format with HLI field and padding in the PDU header according to embodiments described herein;

FIG. 8 is sixth example PDU format with HLI field including the length of MAC CONTROL ELEMENTS according to embodiments described herein;

FIG. 9 is an example MAC CE structure according to embodiments described herein;

FIG. 10 is a logic flow diagram for structuring PDUs, and illustrates the operation of an exemplary method, a result of execution of computer program instructions embodied on a computer readable memory, functions performed by logic implemented in hardware, and/or interconnected means for performing functions in accordance with exemplary embodiments; and

FIG. 11 is a logic flow diagram for structuring PDUs, and illustrate the operation of an exemplary method, a result of execution of computer program instructions embodied on a computer readable memory, functions performed by logic implemented in hardware, and/or interconnected means for performing functions in accordance with exemplary embodiments.

### DETAILED DESCRIPTION

The exemplary embodiments herein describe techniques for structuring PDUs. Additional description of these techniques is presented after a system into which the exemplary embodiments may be used is described.

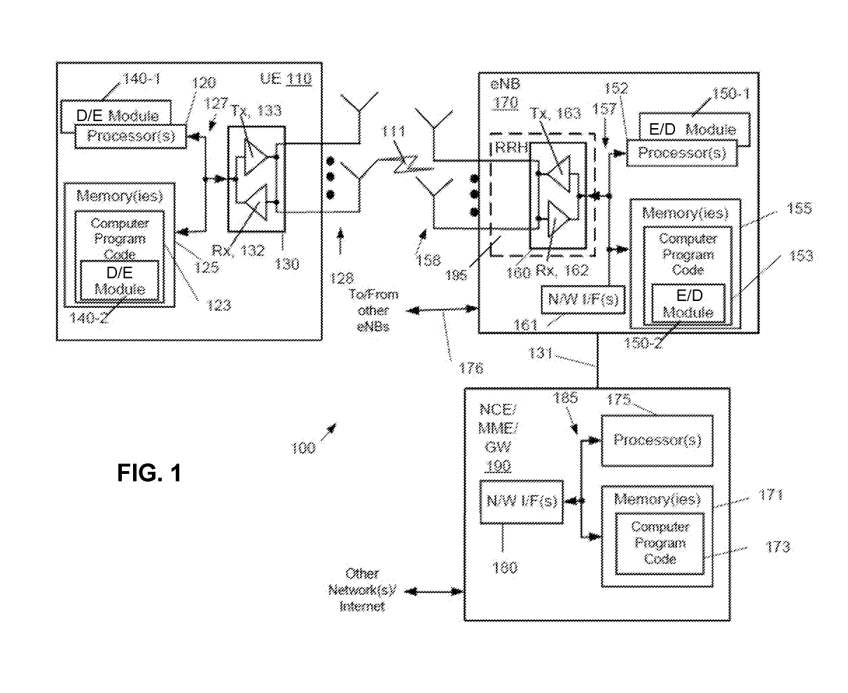

Turning to FIG. 1, this figure shows a block diagram of one possible and non-limiting exemplary system in which the exemplary embodiments may be practiced. In FIG. 1, a UE 110 is in wireless communication with a wireless network 100. The user equipment 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a D/E (Decoding/Encoding) module 140, comprising one of or both parts 140-1 and/or 140-2, which may be implemented in a number of ways. The D/E module 140 may be implemented in hardware as D/E part 140-1, such as being implemented as part of the one or more processors 120. The D/E part 140-1 may be implemented also as an integrated circuit or through other hardware such as a programmable gate array. In another example, the D/E module 140 may be implemented as D/E part 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with eNB 170 via a wireless link 111.

The eNB 170 is a base station that provides access by wireless devices such as the UE 110 to the wireless network 100. The eNB 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The eNB 170 includes a Encoding/Decoding (E/D) module 150, comprising one of or both parts 150-1 and/or 150-2, which may be implemented in a number of ways. The E/D module 150 may be implemented in hardware as E/D part 150-1, such as being implemented as part of the one or more processors 152. The E/D part 150-1 may be implemented also as an integrated circuit or through other hardware such as a programmable gate array. In another example, the E/D module 150 may be implemented as E/D part 150-2, which is implemented as computer program code 153 and is executed by the one or more processors 152. For instance, the one or more memories 155 and the computer program code 153 are configured to, with the one or more processors 152, cause the eNB 170 to perform one or more of the operations as described herein. The one or more network interfaces 161 communicate over a network such as via the links 176 and 131. Two or more eNBs 170 communicate using, e.g., link 176. The link 176 may be wired or wireless or both and may implement, e.g., an X2 interface.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195, with the other elements of the eNB 170 being physically in a different location from the RRH, and the one or more buses 157 could be implemented in part as fiber optic cable to connect the other elements of the eNB 170 to the RRH 195.

The wireless network 100 may include a network control element (NCE) 190 that may include MME/SGW functionality, and which provides connectivity with a further network, such as a telephone network and/or a data communications network (e.g., the Internet). The eNB 170 is coupled via a link 131 to the NCE 190. The link 131 may be implemented as, e.g., an S1 interface. The NCE 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the NCE 190 to perform one or more operations.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, eNB 170, and other functions as described herein.

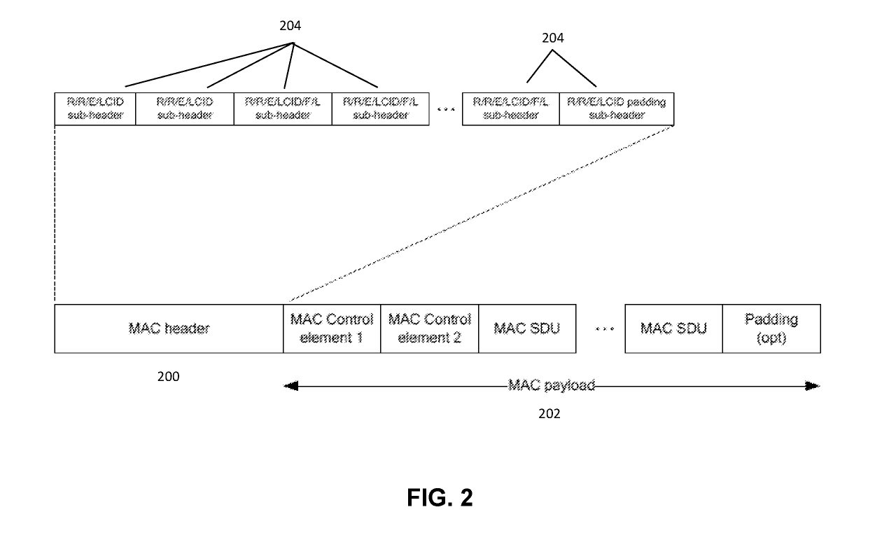

Typically, LTE systems use MAC PDU structures, such as the MAC PDU structure specified in “3GPP TS 36.321 V12.5.0, Medium Access Control (MAC) protocol specification”. FIG. 2 illustrates an example LTE MAC PDU structure according to TS36.321. FIG. 2 shows a MAC header 200 followed by a MAC payload 202. The MAC header 200 has various sub-headers 204, where each sub-header 204 includes extension bit ‘E’. Sub-headers which contain the extension bit ‘F’ indicate a corresponding payload part length. Specifically, the E bit indicates whether another MAC sub-header will follow, and the F bit indicates whether the length field is 7 or 15 bit long. If the E bit indicates another sub-header will follow, then from the Logical Channel Identifier (LCID) the receiver determines whether length field, L, will follow.

The structure as shown in FIG. 2, requires the decoding entity (e.g. a receiver) to wade through the whole MAC header before it can determine where the MAC payload part begins in the PDU. Additionally, the decoding entity needs to place each sub-header it reads in memory and then re-read the information once the decoding entity reaches the end of the MAC header and has started to decode the payload part 202. With the envisioned throughputs of future communication networks (e.g. 5G), more efficient processing of PDU structures is needed in order to comply with the demanding energy consumption requirements.

Embodiments described herein present an optimized PDU encoding method which may enable, for example, a decoding entity to process the received PDU in multiple parallel processes; a specific field indicates the length of the PDU header which serves as a pointer for the starting position of the payload part in the PDU. Alternatively or additionally, the specific field may also indicate the part of PDU reserved for padding.

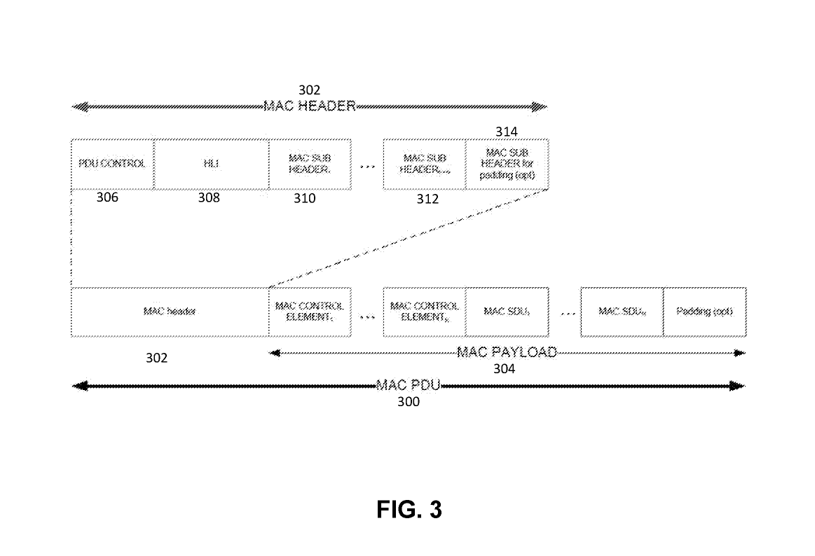

According to certain embodiments, a special length indicator field element in the PDU header is used to indicate the length of the PDU header, which for example may be called Header Length Indicator (HLI). FIG. 3 illustrates an example format of a MAC PDU 300. The MAC PDU 300 includes a MAC Header 302 and a MAC Payload 304. The MAC Header 302 contains various sub-headers including: PDU Control 306; HLI field 308; MAC sub-headers 310, 312; and optional MAC sub-header 312 for padding. The presence and length of the HLI field 308 in the MAC PDU 300 can be configurable by the PDU type specified in PDU Control 306 field or configured by higher layers, for example the RRC layer. When HLI field 308 indicates the length of the MAC header 302, the decoding entity can determine the start position of the MAC Payload 304 part in the MAC PDU 300 and start decoding the elements immediately after reading the corresponding sub-headers.

In certain embodiments, the HLI field 306 may indicate the length of the whole MAC Header 302 including the PDU Control 306 and HLI field 308. Alternatively, the HLI field 308 may indicate the length of the remaining part of the MAC header 302 after the HLI field 308.

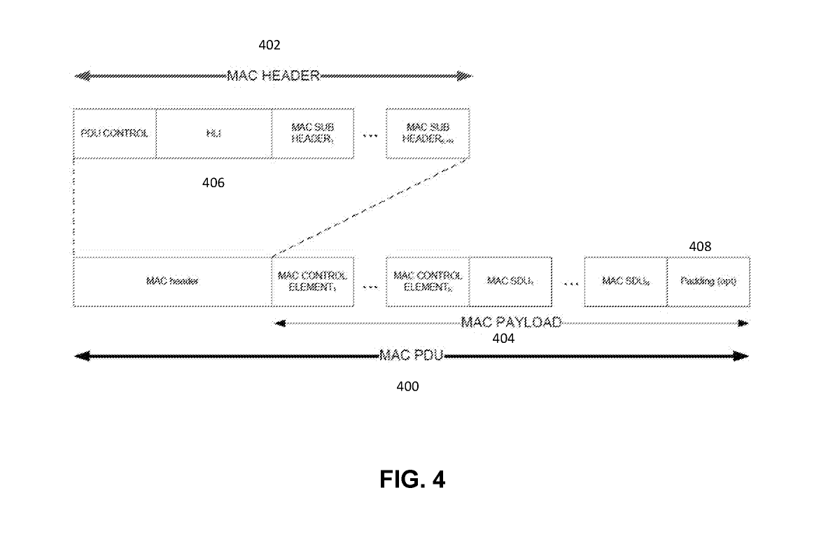

Alternatively or additionally, example formats may use the HLI field, when present, to indicate the presence and/or amount of padding in the MAC PDU. The length of the padding may be zero. Some of these example formats are described in detail with reference to FIGS. 4-7.

FIG. 4 illustrates another example format for a MAC PDU. Here, the MAC PDU 400 includes the MAC Header 402 part and the MAC Payload 404 part. The MAC Header 402 part contains the HLI field 406. According to this example format, the decoding entity may calculate the length of the MAC Header 402 based on the HLI field 406, and the length of each element in the Mac Payload 404 (for instance, from the corresponding sub-headers or from the beginning of each payload element) and determines whether there is padding 408 in the MAC PDU 400. In this example, it is assumed that the TB size is known to decoding entity, e.g., by lower layer means. For example, UE might be a target entity and receive a PDU including a downlink (DL) assignment; or the UE might be the source entity and the PDU may include an uplink (UL) grant. The padding can be placed in the end of the PDU header 402, after the PDU header 402, or in the end of the MAC PDU 400.

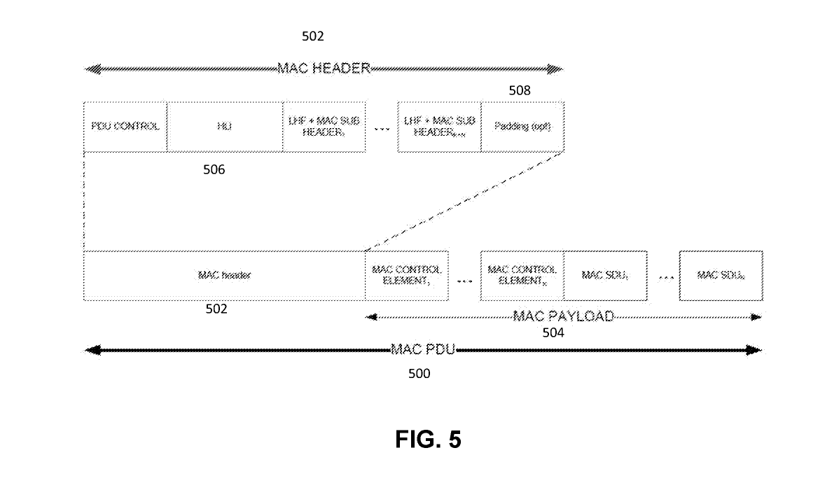

FIG. 5 illustrates a further example format for a MAC PDU. According to FIG. 5, the MAC PDU 500 comprises the MAC Header 502. The MAC Header 502 part may include the Padding 508, and each sub-header includes a last sub-header flag (LHF, 1 bit). The LHF flag indicates when the padding part begins. The HLI field 506 specifies the whole header part length including the padding 508.

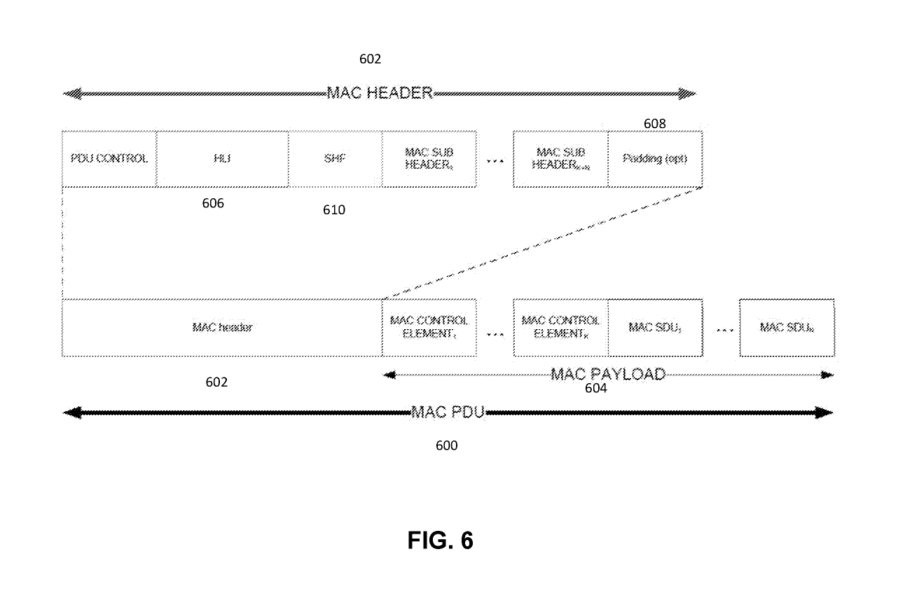

FIG. 6 illustrates another example format for a MAC PDU. In FIG. 6, the MAC PDU 600 comprises both the MAC Header 602 part and the MAC Payload 604 part. The MAC Header part may include padding 608 and also SHF Field 610 which indicates the amount of sub-header fields (SHF) in the MAC PDU header 602. The HLI field 606 still specifies the whole header part, including any padding. The length of SHF field 610 may be configurable.

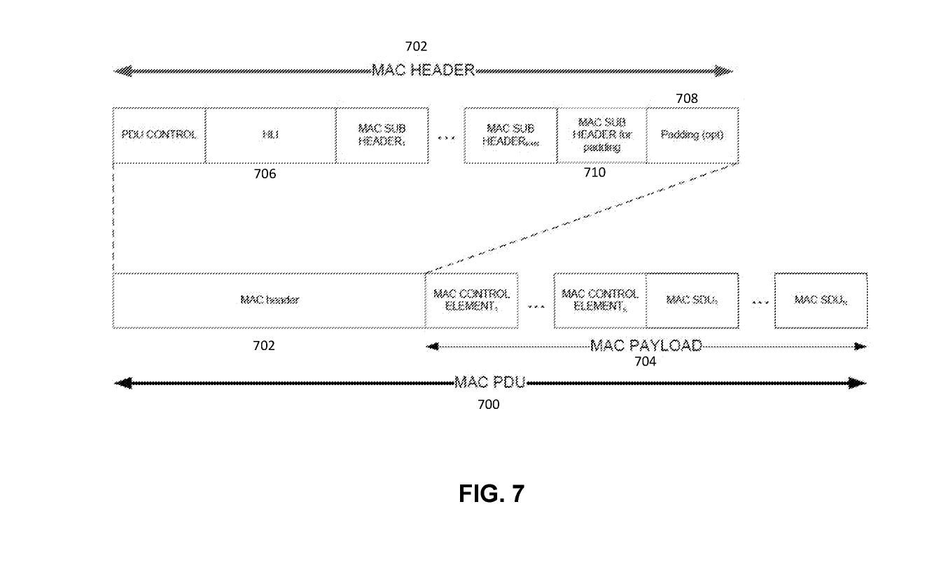

FIG. 7 illustrates a further example format of a MAC PDU. The MAC PDU 700 comprises the MAC Header 702 part and the MAC Payload 704 part. In this example, the MAC Header 702 part includes both the padding 708 and a specific field (“MAC SUB Header for padding field”) 710, which indicates where the padding 708 part starts in the MAC PDU Header 702. The HLI field 706 specifies the length of the whole header part 702, including the padding 708. The field 710 can indicate, for example, Logical Channel Identifier (LCID) reserved for padding and is either always mandatorily present in the header whether or not the PDU includes padding bytes after the padding header (the field serves as delimiter when the sub-headers part ends in the PDU header) or only when padding is required.

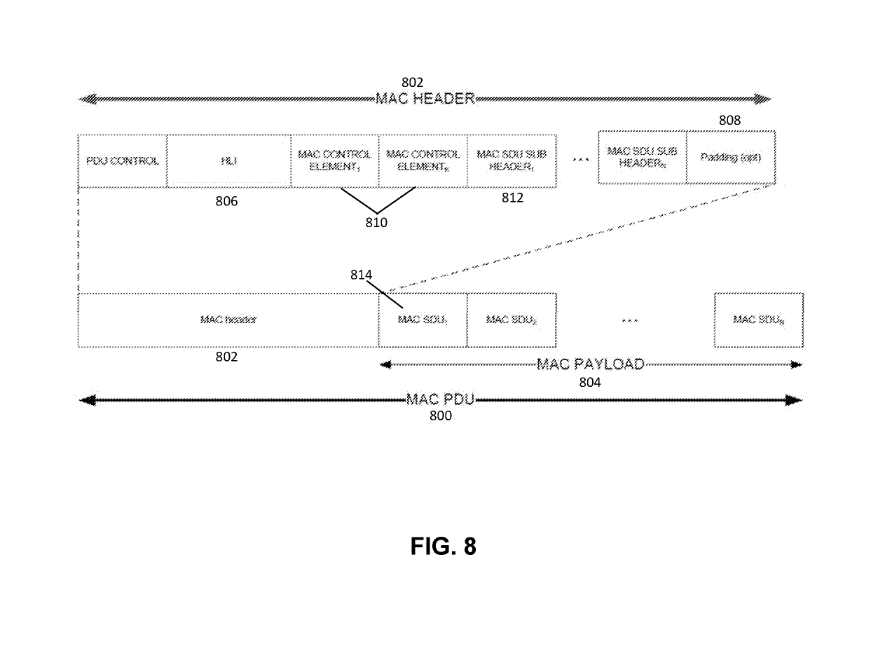

FIG. 8 illustrates a further example format of a MAC PDU. The MAC PDU 800 comprises the MAC Header 802 part and the MAC Payload 804 part. The MAC Header 802 part include the HLI field 806. In this example format, the length indicated by the HLI field 806 may include the MAC CONTROL ELEMENTs 810 lengths (where the MAC CE 810 includes the sub-header part). Alternatively, the MAC CONTROL may follow after the MAC Service Data Unit (SDU) sub-headers. The decoding entity may start decoding the MAC payload 804 part after reading the HLI 806 field and the first MAC SDU sub-header 812.

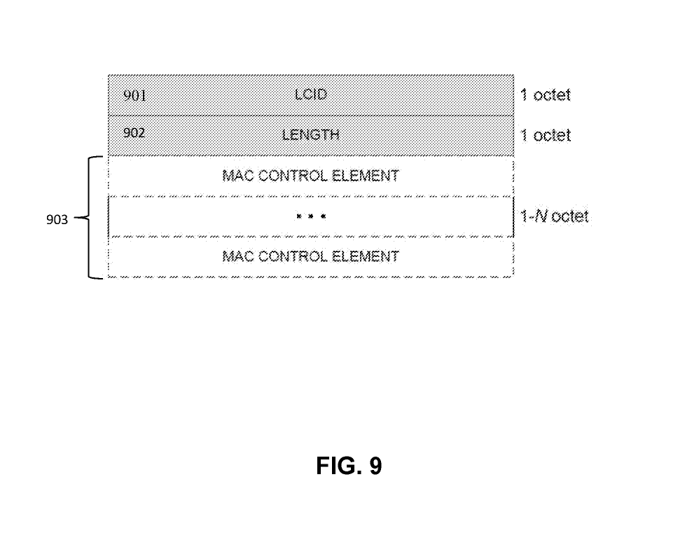

FIG. 9 illustrates an example MAC CONTROL ELEMENT structure. In FIG. 9 the MAC CONTROL ELEMENT format/type is identified by the LCID 901 and the MAC CONTROL ELEMENT length with the length field 902, MAC CONTROL ELEMENT 903 includes the corresponding MAC control information. In one example MAC CONTROL ELEMENT 903 format the padding may be included in the PDU Header. Alternatively, the padding could also be included in the PDU payload part.

According to one embodiment, the mode to indicate the padding in the PDU may be configurable by the PDU type specified in the PDU CONTROL field (e.g. PDU CONTROL 306 in FIG. 3) or may be configurable by higher layers like RRC.

According to some embodiments, the PDU format containing the SHF field is used when the number of sub-headers in PDU header is more than the length of SHF in bits. According to some embodiments, the Length Indicator field of the last SDU in the PDU may be omitted.

According to some embodiments, the length of HLI field is determined from the PDU size (e.g., transport block (TB) size in MAC layer) at both the encoding entity and the decoding entity. For a certain embodiment, the HLI field size may be calculated by ROUNDUP(Log2(PDU_size)). For example, if PDU_size=65000B, then the HLI field size is calculated by ROUNDUP(Log2(65000)), which would provide a HLI field size of 16 bits.

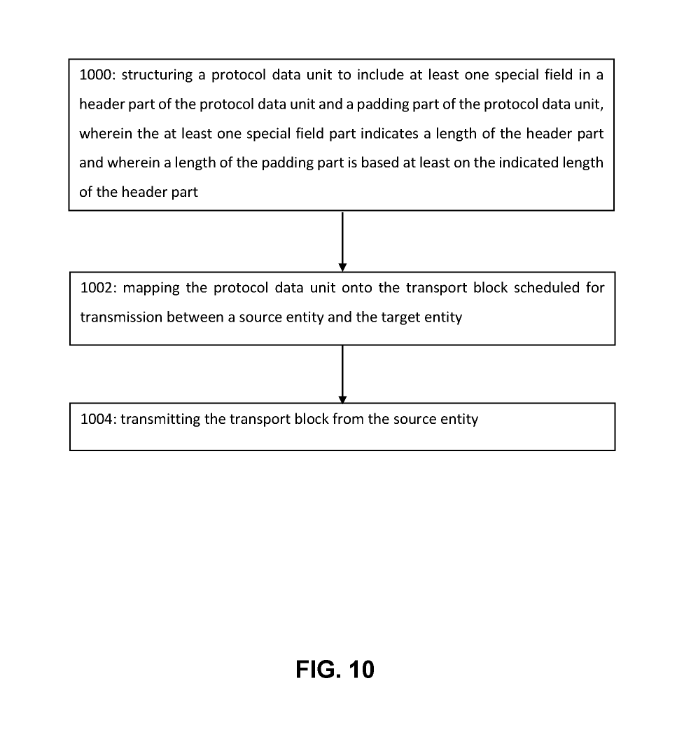

FIG. 10 is a logic flow diagram for structuring protocol data units. This figure further illustrates the operation of an exemplary method, a result of execution of computer program instructions embodied on a computer readable memory, functions performed by logic implemented in hardware, and/or interconnected means for performing functions in accordance with exemplary embodiments. For instance, the E/D module 150 may include multiples ones of the blocks in FIG. 10, where each included block is an interconnected means for performing the function in the block. The blocks in FIG. 10 are assumed to be performed by an encoding entity. The encoding entity may be, for example, the UE 110 of FIG. 1, e.g., under control of the D/E module 140 at least in part. Alternatively, the encoding entity may be a eNB 170, e.g., under control of the E/D module 150 at least in part.

Referring to FIG. 10, an example method may comprise structuring a protocol data unit to include at least one special field in a header part of the protocol data unit and a padding part of the protocol data unit, wherein the at least one special field part indicates a length of the header part and wherein a length of the padding part is based at least on the indicated length of the header part as indicated by block 1000; mapping the protocol data unit onto the transport block scheduled for transmission between a source entity and the target entity as indicated by block 1002, and transmitting the transport block from the source entity as indicated by block 1004.

The header part of the example method may include at least one sub-header indicating presence of at least one control element and/or service data unit in the protocol data unit. The at least one control element may be encoded to the header part of the protocol data unit and the at least one special field in the header part may further indicate the length of the at least one control element. The placement of the padding part may be at least one of: included in the end of the protocol data unit, in the end of the header part of the protocol data unit, and after the header part. The placement of the padding part in the protocol data unit may be indicated in the header part. The length of the padding part included in the protocol data unit may be further based on at least one of: a length of a control element of the protocol data unit and/or a length of a service data unit of the protocol data unit. A start position of the padding part in the header part of the protocol data unit may be indicated by at least one of: a special header field reserved for padding; a bit field included in at least one of a control element and/or service data unit sub-header; and a special header field indicating a number of sub-headers in the header part. An example method may further comprise: configuring a mode to indicate the start position of the padding part in the header part of the protocol data unit. The configuration may be done by at least one of: the source entity using a control field part conveyed in the header part of the protocol data unit; and radio resource control protocol. A length indication of a last element of the protocol data unit may be omitted by the source entity, wherein the last element of the protocol data unit may be at least one of a control element and a service data unit. The example method may configure a length of the at least one special field in the header part. The configuration may be done by at least one of: a source entity using a control field part conveyed in the header part of the protocol data unit; and radio resource control protocol. The total size of the at least one special field and the control field part may be byte aligned; the total size may be 2 or 3 bytes. The size of the at least one special field in the header part may be determined by the size of the transport block by the source entity and the target entity. The header part length of the protocol data unit indicated by the at least one special field in the header part may not apply to the at least one special field and a control field part. The example method may comprise prior to the structuring, determining a size of the transport block scheduled for transmission; wherein the length of the padding part may be further based on the size of the transport block.

An example embodiment may be provided in an apparatus, for example eNB 170 or UE 110 as shown in FIG. 1, comprising at least one processor; and at least one non-transitory memory including computer program code, the at least one memory and the computer program code are configured to, with the at least one processor, cause the apparatus to: structure a protocol data unit to include at least one special field in a header part of the protocol data unit and a padding part of the protocol data unit, wherein the at least one special field part indicates a length of the header part and wherein a length of the padding part is based at least on the indicated length of the header part; mapping the protocol data unit onto the transport block scheduled for transmission between a source entity and the target entity, and transmitting the transport block from the source entity.

The header part of the example method may include at least one sub-header indicating presence of at least one control element and/or service data unit in the protocol data unit. The at least one control element may be encoded to the header part of the protocol data unit and the at least one special field in the header part may further indicate the length of the at least one control element. The placement of the padding part may be at least one of: included in the end of the protocol data unit, in the end of the header part of the protocol data unit, and after the header part. The placement of the padding part in the protocol data unit may be indicated in the header part. The length of the padding part included in the protocol data unit may be further based on at least one of: a length of a control element of the protocol data unit and/or a length of a service data unit of the protocol data unit. A start position of the padding part in the header part of the protocol data unit may be indicated by at least one of: a special header field reserved for padding; a bit field included in at least one of a control element and/or service data unit sub-header; and a special header field indicating a number of sub-headers in the header part. The at least one memory and the computer program code may be configured to, with the at least one processor, cause the apparatus to: configuring a mode to indicate the start position of the padding part in the header part of the protocol data unit. The configuration may be done by at least one of: the source entity using a control field part conveyed in the header part of the protocol data unit; and radio resource control protocol. A length indication of a last element of the protocol data unit may be omitted by the source entity, wherein the last element of the protocol data unit may be at least one of a control element and a service data unit. The example method may configure a length of the at least one special field in the header part. The configuration may be done by at least one of: a source entity using a control field part conveyed in the header part of the protocol data unit; and radio resource control protocol. The total size of the at least one special field and the control field part may be byte aligned; the total size may be 2 or 3 bytes. The size of the at least one special field in the header part may be determined by the size of the transport block by the source entity and the target entity. The header part length of the protocol data unit indicated by the at least one special field in the header part may not apply to the at least one special field and a control field part. The at least one memory and the computer program code may be configured to, with the at least one processor, cause the apparatus to prior to the structuring, determining a size of the transport block scheduled for transmission; wherein the length of the padding part may be further based on the size of the transport block.

An example embodiment may be provided in non-transitory program storage device, such as one of the memories 125, 155 shown in FIG. 1 for example, readable by a machine, tangibly embodying a program of instructions executable by the machine for performing operations, the operations may comprise structuring a protocol data unit to include at least one special field in a header part of the protocol data unit and a padding part of the protocol data unit, wherein the at least one special field part indicates a length of the header part and wherein a length of the padding part is based at least on the indicated length of the header part; mapping the protocol data unit onto the transport block scheduled for transmission between a source entity and the target entity, and transmitting the transport block from the source entity.

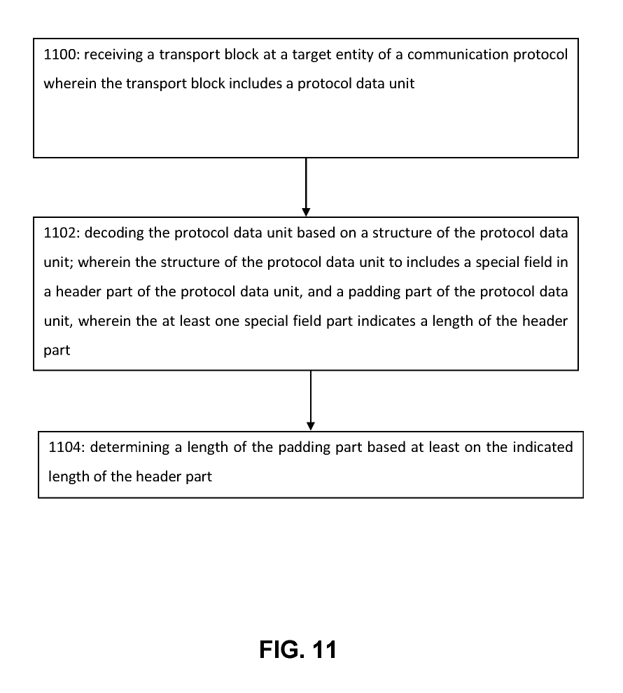

FIG. 11 is a logic flow diagram for decoding protocol data units. This figure further illustrates the operation of an exemplary method, a result of execution of computer program instructions embodied on a computer readable memory, functions performed by logic implemented in hardware, and/or interconnected means for performing functions in accordance with exemplary embodiments. For instance, the D/E module 140 or E/D module 150 may include multiples ones of the blocks in FIG. 10, where each included block is an interconnected means for performing the function in the block. The blocks in FIG. 11 are assumed to be performed by the decoding entity. The decoding entity may be, for example, the UE 110 of FIG. 1, e.g., under control of the D/E module 140 at least in part. Alternatively, the decoding entity may be an eNB 170, e.g., under control of the E/D module 150 at least in part.

Referring to FIG. 11, an example method may comprise receiving a transport block at a target entity of a communication protocol wherein the transport block includes a protocol data unit as indicated by block 1100; decoding the protocol data unit based on a structure of the protocol data unit; wherein the structure of the protocol data unit to includes a special field in a header part of the protocol data unit, and a padding part of the protocol data unit, wherein the at least one special field part indicates a length of the header part as indicated by block 1102; and determining a length of the padding part based at least on the indicated length of the header part as indicated by block 1104.

An example embodiment may be provided in an apparatus, for example eNB 170 or UE 110 as shown in FIG. 1, comprising at least one processor; and at least one non-transitory memory including computer program code, the at least one memory and the computer program code are configured to, with the at least one processor, cause the apparatus to: receive a transport block at a target entity of a communication protocol wherein the transport block includes a protocol data unit; decode the protocol data unit based on a structure of the protocol data unit; wherein the structure of the protocol data unit to includes a special field in a header part of the protocol data unit, and a padding part of the protocol data unit, wherein the at least one special field part indicates a length of the header part; and determine a length of the padding part based at least on the indicated length of the header part.

An example embodiment may be provided in non-transitory program storage device, such as one of the memories 125, 155 shown in FIG. 1 for example, readable by a machine, tangibly embodying a program of instructions executable by the machine for performing operations, the operations may comprise receiving a transport block at a target entity of a communication protocol wherein the transport block includes a protocol data unit; decoding the protocol data unit based on a structure of the protocol data unit; wherein the structure of the protocol data unit to includes a special field in a header part of the protocol data unit, and a padding part of the protocol data unit, wherein the at least one special field part indicates a length of the header part; and determining a length of the padding part based at least on the indicated length of the header part.

The embodiments described herein optimize processing in the decoding entity which may enable the decoding entity to use multiple parallel processes to decode each separate payload part of the PDU. Additionally, embodiments described herein may alleviate the encoding entity's processing for the PDU header generation because no separate padding header in the PDU is required. Certain embodiments described herein enable transmission of bigger SDUs than the Length Indicator field could be able to indicate. This is accomplished, for example, by omitting the length indication from the last SDU regardless of whether there is padding or not in the PDU.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memories 125, 155, 171 or other device) that may be any media or means that can contain, store, and/or transport the instructions for use by or in connection with an instruction execution system, apparatus, or device, such as a computer.

Any combination of one or more computer readable medium(s) may be utilized as the memory. The computer readable medium may be a computer readable signal medium or a non-transitory computer readable storage medium. A non-transitory computer readable storage medium does not include propagating signals and may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing

If desired, the different functions discussed herein may be performed in a different order and/or concurrently with each other. Furthermore, if desired, one or more of the above-described functions may be optional or may be combined.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
CE Control Element
HLI Header Length Indicator
LCID Logical Channel Identifier
LHF Last Header Flag
MAC Medium Access Control
PDU Protocol Data Unit
RLC Radio Link Control
RRC Radio Resource Control
SDU Service Data Unit
SHF Sub-Header Fields
TB Transport Block

1. A method comprising:
structuring a protocol data unit to include at least one special field in a header part of the protocol data unit and a padding part of the protocol data unit, wherein the at least one special field indicates a length of the header part and wherein a length of the padding part is based at least on the indicated length of the header part;
mapping the protocol data unit onto a transport block scheduled for transmission between a source entity and a target entity, and
transmitting the transport block from the source entity.

2-12. (canceled)

13. An apparatus comprising:
at least one processor; and
at least one non-transitory memory including computer program code,
the at least one memory and the computer program code are configured to, with the at least one processor, cause the apparatus to:
structure a protocol data unit to include at least one special field in a header part of the protocol data unit and a padding part of the protocol data unit, wherein the at least one special field indicates a length of the header part and wherein a length of the padding part is based at least on the indicated length of the header part;
map the protocol data unit onto a transport block scheduled for transmission between a source entity and a target entity, and
transmit the transport block from the source entity.

14. The apparatus of claim 13, wherein the header part of the protocol data unit includes at least one sub-header indicating presence of at least one control element and/or service data unit in the protocol data unit.

15. The apparatus of claim 14, wherein the at least one control element is encoded to the header part of the protocol data unit and wherein the at least one special field in the header part further indicates the length of the at least one control element.

16. The apparatus of claim 13, wherein placement of the padding part is at least one of:
included in the end of the protocol data unit,
in the end of the header part of the protocol data unit, or
after the header part.

17. The apparatus of claim 16, wherein the placement of the padding part in the protocol data unit is indicated in the header part.

18. The apparatus of claim 13, wherein the length of the padding part included in the protocol data unit is further based on at least one of:
a length of a control element of the protocol data unit indicated in the at least one special field; and/or
a length of a service data unit length of the protocol data unit indicated in the at least one special field.

19. The apparatus of claim 13, wherein a start position of the padding part in the header part of the protocol data unit is indicated by at least one of:
a special header field reserved for padding;
a bit field included in at least one of a control element and/or service data unit sub-header; and
a special header field indicating a number of sub-headers in the header part.

20. The apparatus of claim 19, further comprising:
configuring a mode to indicate the start position of the padding part in the header part of the protocol data unit.

21. The apparatus of claim 20, wherein the configuration is done by at least one of:
the source entity using a control field part conveyed in the header part of the protocol data unit; or
radio resource control protocol.

22. The apparatus of claim 13,
wherein a length indication of a last element of the protocol data unit is omitted by the source entity, wherein the last element of the protocol data unit is at least one of a control element or a service data unit.

23. The apparatus of claim 13, wherein the at least one memory and the computer program code are configured to, with the at least one processor, cause the apparatus to:
configure a length of the at least one special field in the header part.

24. The apparatus of claim 23, wherein the configuration is done by at least one of:
the source entity using a control field part conveyed in the header part of the protocol data unit; and
radio resource control protocol.

25. The apparatus of claim 24, wherein a total size of the at least one special field and the control field part is byte aligned.

26. The apparatus of claim 25, wherein the total size is 2 or 3 bytes.

27. The apparatus of claim 13, wherein the size of the at least one special field in the header part is determined by the size of the transport block by the source entity and the target entity.

28. The apparatus of claim 13, wherein the header part length of the protocol data unit indicated by the at least one special field in the header part does not apply to the at least one special field and a control field part.

29. The apparatus of claim 13, wherein the at least one memory and the computer program code are configured to, with the at least one processor, cause the apparatus to:
prior to the structuring, determine a size of the transport block scheduled for transmission; wherein the length of the padding part is further based on the size of the transport block.

30-32. (canceled)

33. An apparatus comprising:
at least one processor; and
at least one non-transitory memory including computer program code,
the at least one memory and the computer program code are configured to, with the at least one processor, cause the apparatus to:
receive a transport block at a target entity of a communication protocol wherein the transport block includes a protocol data unit;
decode the protocol data unit based on a structure of the protocol data unit; wherein the structure of the protocol data unit to includes a special field in a header part of the protocol data unit, and a padding part of the protocol data unit, wherein the at least one special field part indicates a length of the header part; and
determine a length of the padding part based at least on the indicated length of the header part.

34-35. (canceled)

36. The apparatus of claim 33, wherein the header part of the protocol data unit comprises at least one sub-header indicating presence of at least one control element and/or service data unit in the protocol data unit.
